(19) United States
(12) Patent Application Publication
(10) Pub. No.: US 2025/0190581 A1
(43) Pub. Date: Jun. 12, 2025

(54) INFORMATION PROCESSING APPARATUS, INFORMATION PROCESSING METHOD, AND COMPUTER READABLE RECORDING MEDIUM

(71) Applicant: NEC Corporation, Minato- ku, Tokyo (JP)

(72) Inventors: Itaru Hosomi, Tokyo (JP); Yusuke Takahashi, Tokyo (JP); Daichi Hasumi, Tokyo (JP)

(73) Assignee: NEC Corporation, Minato- ku, Tokyo (JP)

(21) Appl. No.: 18/840,158

(22) PCT Filed: Mar. 2, 2022
(86) PCT No.: PCT/JP2022/008895

§ 371 Date: Aug. 21, 2024

(51) Int. Cl. G06F 21/57

(52) U.S. Cl. CPC G06F 21/577; G06F 2221/034

(57) ABSTRACT

An information processing apparatus includes: an exercise condition acquisition unit that acquires an execution duration of a cybersecurity exercise specified by a participant of the cybersecurity exercise, as an exercise condition; and an attack operation creation unit that creates a series of attack operations to be executed in the cybersecurity exercise by creating a scenario of a cyberattack to be used in the cybersecurity exercise, and extracting a part of the created scenario that falls within the specified exercise duration.

### TECHNICAL FIELD

The present disclosure relates to an information processing apparatus and an information processing method for providing support to training for defense against cyberattacks, and further relates to a computer readable recording medium on which a program for implementing the same is recorded.

### BACKGROUND ART

In recent years, there have been increasing damage from cyberattacks aimed at organizations, such as leakage of information and suspension of business operations, and there has been demand for enhancement of countermeasures against cyberattacks. In order to enhance countermeasures against cyberattacks, it is essential to improve the research skills of persons in charge of system security. Thus, cybersecurity exercises (or cyber exercises) are provided to participants who are required to find a log that is a trace of an incident (hereinafter, described as “attack log”).

In such cybersecurity exercises, it is important to prepare logs including attack logs of various cyberattacks, as training material. In actuality, however, it is difficult to collect a large number of logs of various cyberattacks by one specific organization and share the logs among a plurality of organizations. To handle this problem, Patent Document 1 discloses an apparatus that creates attack scenarios for virtual cyberattacks. The apparatus disclosed in Patent Document 1 creates an attack scenario by properly arranging program components using information indicating the relationship among the program components.

The use of the apparatus disclosed in Patent Document 1 makes it possible to, in a cybersecurity exercise, execute virtual cyberattacks on a training computer system along the created attack scenario, thereby collecting attack logs from the training computer system.

### LIST OF RELATED ART DOCUMENT

### Patent Document

Patent Document 1: Japanese Patent Laid-Open Publication No. 2021-120780

### SUMMARY OF INVENTION

### Problems to be Solved by the Invention

In order to enhance the effect of a cybersecurity exercise, a large number of persons in charge need to perform the cybersecurity exercise a number of times. However, in a conventional cybersecurity exercise, it is not considered that the training is provided to participants according to each individual's convenience, and the exercise duration is the same for all the participants.

This causes a problem that it may be difficult to provide a conventional cybersecurity exercise to a large number of persons in charge. In addition, the apparatus disclosed in Patent Document 1 does not include a means for adjusting the duration of the cybersecurity exercise according to each participant's convenience, and will not be able to solve the above-described problem.

An example object of the present disclosure is to provide an information processing apparatus, an information processing method, and a computer readable recording medium that make it possible to provide a cybersecurity exercise that is suited to each individual participant's wish.

### Means for Solving the Problems

In order to achieve the above-described object, an information processing apparatus includes:
an exercise condition acquisition unit that acquires an execution duration of a cybersecurity exercise specified by a participant of the cybersecurity exercise, as an exercise condition; and
an attack operation creation unit that creates a series of attack operations to be executed in the cybersecurity exercise by creating a scenario of a cyberattack to be used in the cybersecurity exercise, and extracting a part of the created scenario that falls within the specified exercise duration.

In order to achieve the above-described object, an information processing method includes:
an exercise condition acquisition step of acquiring an execution duration of a cybersecurity exercise specified by a participant of the cybersecurity exercise, as an exercise condition; and
an attack operation creation step of creating a series of attack operations to be executed in the cybersecurity exercise by creating a scenario of a cyberattack to be used in the cybersecurity exercise, and extracting a part of the created scenario that falls within the specified

In order to achieve the above-described object, a computer readable recording medium according to an example aspect of the invention is a computer readable recording medium that includes recorded thereon a program,
the program including instructions that cause the computer to carry out:
an exercise condition acquisition step of acquiring an execution duration of a cybersecurity exercise specified by a participant of the cybersecurity exercise, as an exercise condition; and
an attack operation creation step of creating a series of attack operations to be executed in the cybersecurity exercise by creating a scenario of a cyberattack to be used in the cybersecurity exercise, and extracting a part of the created scenario that falls within the specified exercise duration.

### Advantageous Effects of the Invention

As described above, according to present disclosure, it is possible to provide a cybersecurity exercise that is suited to each individual participant's wish.

### BRIEF DESCRIPTION OF THE DRAWINGS

FIG. 1 is a configuration diagram illustrating a schematic configuration of the information processing apparatus according to the first example embodiment.

FIG. 2 is a configuration diagram specifically illustrating a configuration of the information processing apparatus according to the first example embodiment.

FIG. 3 is a diagram illustrating an example of attack type information used in the first example embodiment.

FIG. 4 is a diagram illustrating an example of software information used in the first example embodiment.

FIG. 5 is a diagram describing processing executed by the attack scenario creation unit in the first example embodiment.

FIG. 6 is a diagram illustrating an example of an attack scenario created in the first example embodiment.

FIG. 7 is a diagram illustrating an example of extraction conditions used in the first example embodiment.

FIG. 8 is a flowchart of operations of the information processing apparatus according to the first example embodiment.

FIG. 9 is a diagram illustrating an example of an exercise condition specification screen.

FIG. 10 is a diagram illustrating an example of a log output by the computer system.

FIG. 11 is a diagram illustrating another example of a log output by the computer system.

FIG. 12 is a configuration diagram illustrating a configuration of the information processing apparatus according to the second example embodiment.

FIG. 13 is a diagram illustrating an example of non-attack operation information used in the second example embodiment.

FIG. 14 is a flowchart of operations of the information processing apparatus according to the second example embodiment.

FIG. 15 is a block diagram illustrating an example of a computer that realizes the information processing apparatus according to the first and second example embodiment.

### EXAMPLE EMBODIMENTS

### First Embodiment

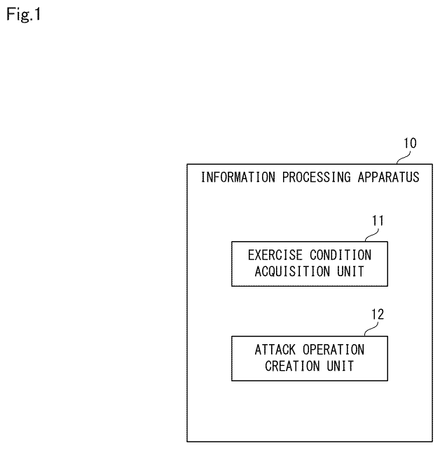

Hereinafter, an information processing apparatus, an information processing method, and a program according to a first example embodiment will be described with reference to FIGS. 1 to 11.

### [Apparatus Configuration]

First, a schematic configuration of an information processing apparatus according to the first example embodiment will be described with reference to FIG. 1. FIG. 1 is a configuration diagram illustrating a schematic configuration of the information processing apparatus according to the first example embodiment.

An information processing apparatus 10 according to the first example embodiment illustrated in FIG. 1 is an apparatus for providing support to training for defense against cyberattacks, for example, providing a cybersecurity exercise. As illustrated in FIG. 1, the information processing apparatus 10 includes an exercise condition acquisition unit 11 and an attack operation creation unit 12.

The exercise condition acquisition unit 11 acquires, as an exercise condition, the execution duration of an exercise specified by a participant of the cybersecurity exercise. The attack operation creation unit 12 creates a scenario of cyberattacks by a virtual attacker, which is used in the cybersecurity exercise. The attack operation creation unit 12 then extracts a part of the created scenario that falls within the specified execution duration, thereby to create a series of attack operations to be executed in the cybersecurity exercise.

As described above, in the first example embodiment, the information processing apparatus 10 creates a series of attack operations to be executed in the cybersecurity exercise, in accordance with the execution duration of the exercise specified by the participant of the cybersecurity exercise. Thus, the information processing apparatus 10 can provide a cybersecurity exercise that is suited to each individual participant's need.

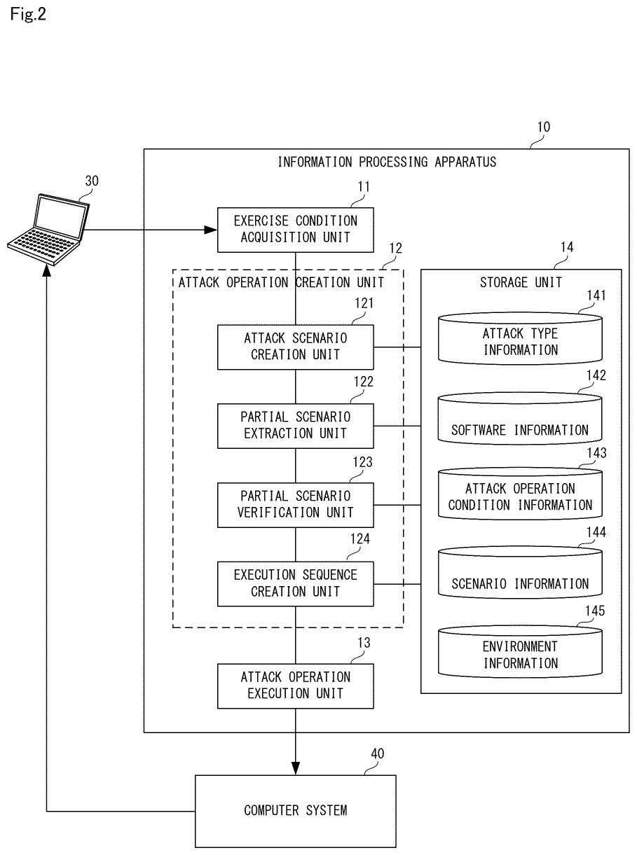

Subsequently, a configuration and functions of the information processing apparatus 10 according to the first example embodiment will be specifically described with reference to FIGS. 2 to 9. FIG. 2 is a configuration diagram specifically illustrating a configuration of the information processing apparatus according to the first example embodiment.

As illustrated in FIG. 2, in the first example embodiment, the information processing apparatus 10 is connected via a network to the participant's terminal device 30 and a computer system 40 for executing the cybersecurity exercise, in a manner capable of data communication. In addition, as illustrated in FIG. 2, the information processing apparatus 10 includes, in addition to the exercise condition acquisition unit 11 and the attack operation creation unit 12 described above, an attack operation execution unit 13 and a storage unit 14.

In the first example embodiment, the participant specifies the execution duration of the exercise on the terminal device 30. Specifically, the participant can specify the start date and time of the exercise and the end date and time of the exercise. The exercise condition acquisition unit 11 calculates the execution duration of the exercise from the start date and time of the exercise and the end date and time of the exercise, and acquires the start date and time of the exercise and the execution duration of the exercise as exercise conditions. The participant can also specify the start date and time of the exercise and the execution duration of the exercise. Also in this case, the exercise condition acquisition unit 11 acquires the start date and time of the exercise and the execution duration of the exercise as exercise conditions.

In the first example embodiment, the participant can also specify, in addition to the execution duration of the exercise, the type of a cyberattack (hereinafter, described as “attack type”). Specifically, the participant specifies the cyberattack type by entering the past case, the attack group (or attack tool), or the attack purpose listed below, for example. In this case, the exercise condition acquisition unit 11 acquires, in addition to the specified execution duration, the cyberattack type as an exercise condition, from the terminal device 30.
Past case: Case A, case B, or the like
Attack group (or attack tool): APT29, REvil, Emotet, Cobalt Strike, or the like
Attack purpose: Acquisition of personal information, acquisition of trade secrets, securing of a ransom, coin mining, denial of service, exploitation of information, data encryption, takeover of resources, service outage, or the like

In the first example embodiment, the attack operation creation unit 12 creates a series of attack operations to be executed in the cybersecurity exercise, using attack type information 141, software information 142, attack operation condition information 143, scenario information 144, and environment information 145, which are stored in the storage unit 14. In addition, as illustrated in FIG. 2, the attack operation creation unit 12 includes an attack scenario creation unit 121, a partial scenario extraction unit 122, a partial scenario verification unit 123, and an execution sequence creation unit 124.

The attack scenario creation unit 121 creates a scenario of cyberattack (hereinafter, described as “attack scenario”) by a virtual attacker in accordance with the attack type specified by the participant. The attack scenario is information indicating the attack destination, tactic(s), and technique(s) in each attack stage (step). In the first example embodiment, the attack scenario creation unit 121 creates the attack scenario by examining matching of the attack type acquired as an exercise condition with the attack type information 141.

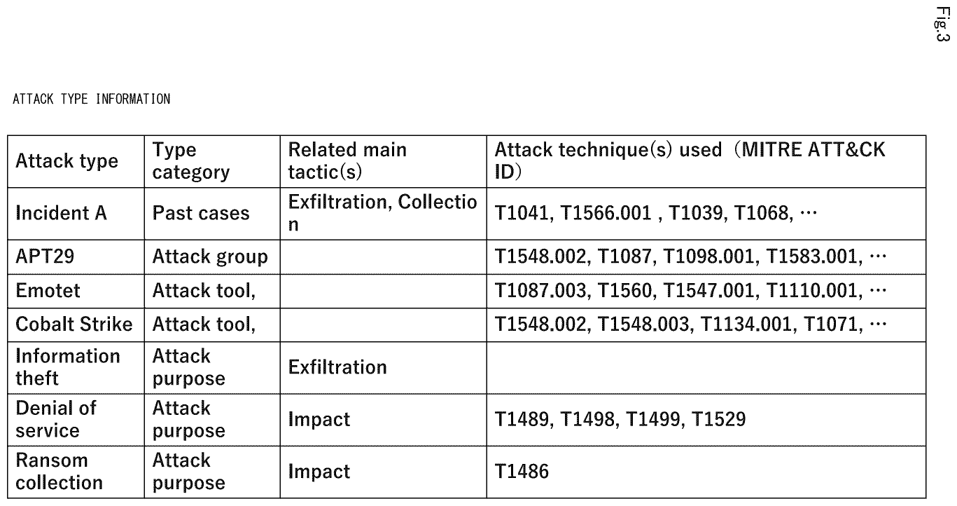

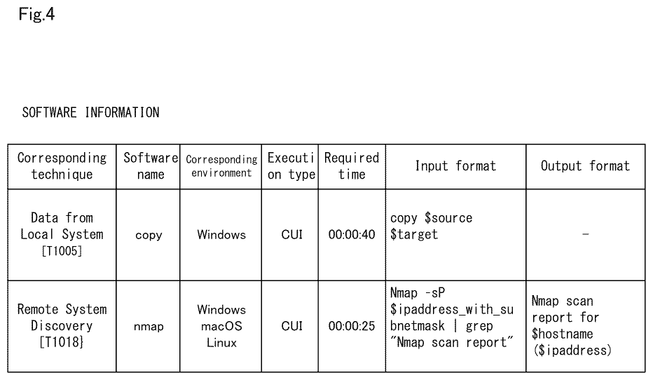

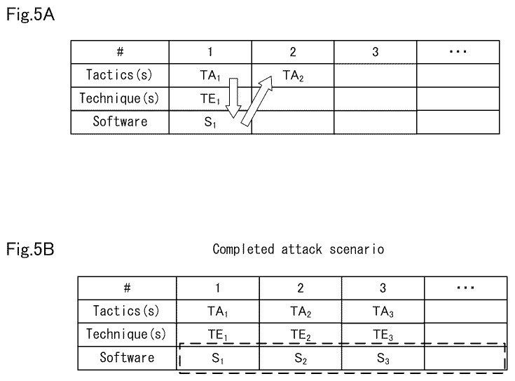

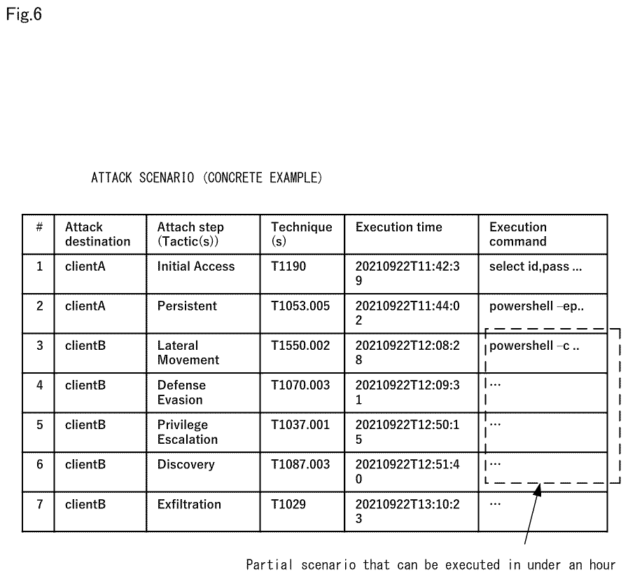

Operations of the attack scenario creation unit 121 will be specifically described with reference to FIGS. 3 to 6. FIG. 3 is a diagram illustrating an example of attack type information used in the first example embodiment. FIG. 4 is a diagram illustrating an example of software information used in the first example embodiment. FIG. 5 is a diagram describing processing executed by the attack scenario creation unit in the first example embodiment. FIGS. 5A and 5B illustrate the progress of a series of the processing. FIG. 6 is a diagram illustrating an example of an attack scenario created in the first example embodiment.

As illustrated in FIG. 3, the attack type information 141 is information indicating the relationship among the attack type, the tactic(s), and the attack technique(s). The attack type information 141 includes the attack type, and corresponding “Type category”, “Related main tactic(s)”, and “Attack technique(s) used”.

Referring to FIG. 3, for example, “Exfiltration” is a tactic to take outside found important information, “Collection” is a tactic to collect data related to the attack target, and “Impact” is a tactic to manipulate, stop, or break the system and data.

In FIG. 3, “Attack technique(s) used” is represented in the terms used in MITRE ATT & CK ID (refer to https://atack.mitre.org). That is, the numbers such as “T1041” and “T1566.001” are identification numbers for identifying the techniques used in the attacks, which are defined in MITRE ATT & CK ID. The section “Attack technique(s) used” covers all the techniques used in the attack.

As illustrated in FIG. 4, the software information 142 is information indicating the relationship between the techniques and software used in the attacks. The software information 142 includes “Corresponding technique”, “Software name”, “Corresponding environment”, “Execution type”, “Required time”, “Input format”, and “Output format”. The numbers added to the “Corresponding technique” are corresponding MITRE ATT & CK IDs.

The attack scenario creation unit 121 first determines the attack type specified by the participant, from the exercise conditions acquired by the exercise condition acquisition unit 11. Next, the attack scenario creation unit 121 examines matching of the determined attack type with the attack type information 141 (see FIG. 3) to determine the corresponding “Type category”, “Related main tactic(s)”, and “Attack technique(s) used”. The attack scenario creation unit 121 then uses the software information 142 to determine the software corresponding to the techniques included in the “Attack technique(s) used”.

After that, the attack scenario creation unit 121 completes the attack scenario using the determined tactics, techniques, and software as illustrated in FIG. 5. In FIG. 5 “TA₁, TA₂, TA₃, . . . ” indicate the tactics included in the determined “Related main tactic(s)”, “TE₁, TE₂, TE₃, . . . ” indicate the techniques included in the determined “Attack technique(s) used”, and “S₁, S₂, S₃, . . . ” indicate the software corresponding to the techniques.

If the attach type is specified by the attack purpose, the attack scenario creation unit 121 may create an attack scenario such that the specified attack purpose comes last (last tactic).

One of specific examples of the attack scenario created by the attack scenario creation unit 121 is as illustrated in FIG. 6. In the example of FIG. 6, the attack scenario creation unit 121 selects a terminal device that is the attack destination from among the terminal devices constituting the computer system 40, in accordance with the system environment of the terminal devices. In FIG. 6, “Execution time” is obtained by adding “Required time” in the software information (see FIG. 4) to the execution time of the previous attack. Alternatively, “Execution time” may be obtained by further adding a random time to the time obtained by adding the required time.

In FIG. 6, “Execution command” corresponds to “Input format” illustrated in FIG. 4. The execution sequence creation unit 124 described later refers to the environment information 145 stored in the storage unit 14 and inputs the file path to the attack destination, the IP address, and the like to the variable parts of the execution command. The environment information 145 is information that indicates the values of the file path, the IP address, and the like corresponding to parameters ($source, $target, $ipaddress, and the like) for each attack destination (client A, client B, or the like), for example.

The partial scenario extraction unit 122 extracts a part of the created attack scenario that falls within the execution duration of the exercise acquired as an exercise condition, as a partial scenario. Specifically, if the execution duration as an exercise condition is one hour, for example, the partial scenario extraction unit 122 extracts a partial scenario that is executable within one hour.

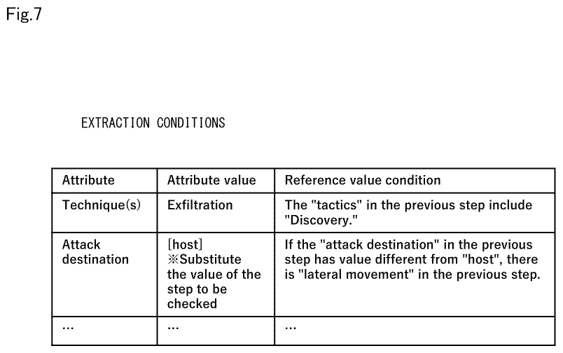

In the first example embodiment, the partial scenario extraction unit 122 determines whether each attack operation in the extracted partial scenario satisfies extraction conditions included in the attack operation condition information 143. If the extracted partial scenario does not satisfy the extraction conditions, the partial scenario extraction unit 122 causes the attack scenario creation unit 121 to create an attack scenario again. FIG. 7 is a diagram illustrating an example of extraction conditions used in the first example embodiment. In the example of FIG. 7, the extraction conditions are set by an attribute value and a reference value condition for each attribute.

After the extraction of the partial scenario, the partial scenario extraction unit 122 associates the identifier (ID) of the participant who has specified the exercise conditions with the extracted partial scenario, and stores them as scenario information 144. The scenario information 144 is information indicating the partial scenario extracted in the past in association with the ID of each participant.

The partial scenario verification unit 123 determines whether the partial scenario extracted by the partial scenario extraction unit 122 is appropriate. Specifically, the partial scenario verification unit 123 examines matching of the ID of the participant who has specified the exercise conditions and the extracted partial scenario with the scenario information 144. Then, the partial scenario verification unit 123 compares the extracted part with the part extracted in the past in association with the identical participant, and determines whether the proportion of an overlap between the two is equal to or greater than a threshold.

If it is determined that the proportion of an overlap between the two is equal to or greater than the threshold, the partial scenario verification unit 123 causes the partial scenario extraction unit 122 to extract another partial scenario from the attack scenario. On the other hand, if it is determined that the proportion of an overlap between the two is not equal to or greater than the threshold, the partial scenario verification unit 123 instructs the execution sequence creation unit 124 to perform processing. The threshold in this case is set as appropriate.

The execution sequence creation unit 124 uses the partial scenario to create a series of attack operations to be executed in the cybersecurity exercise, that is, an execution sequence of attacks. In the execution sequence, execution commands are arranged in the order of execution. In addition, as described above, the execution sequence creation unit 124 inputs the file path to the attack destination, the IP address, and the like to the variable parts of “Execution command” in the attack scenario (see FIG. 6), with reference to the environment information 145 stored in the storage unit 14.

The attack operation execution unit 13 transmits the created series of attack operations, that is, the execution sequence, to the computer system 40 for executing the cybersecurity exercise, and causes the computer system 40 to execute the series of attack operations.

In addition, in the first example embodiment, since the participant specifies the start date and time of the exercise, the attack operation execution unit 13 causes the computer system 40 to execute the series of attack operations in accordance with the specified start date and time. The timing for executing the series of attack operations may be the specified start date and time or may be a random time point within a specific range around the specified start date and time.

As described above, the computer system 40 includes a plurality of terminal devices and a server device, and the commands are executed at the terminal device that is the attack target. After that, the computer system 40 outputs logs that were collected during execution of the series of attack operations. The output logs are used as training material in the participant's cybersecurity exercise.

### [Apparatus Operations]

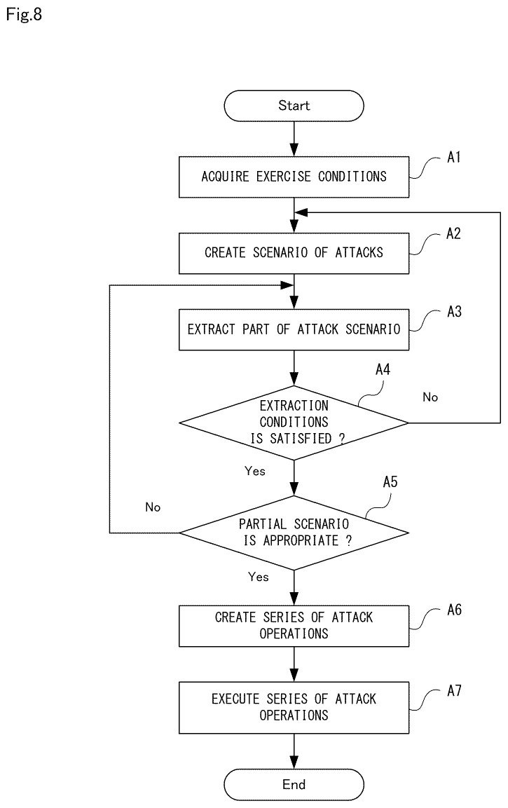

Next, operations of the information processing apparatus 10 according to the first example embodiment will be described with reference to FIGS. 8 to 11. FIG. 8 is a flowchart of operations of the information processing apparatus according to the first example embodiment. In the following description, FIGS. 1 to 7 will also be referred to as appropriate. In the first example embodiment, an information processing method is implemented by operating the information processing apparatus 10. Accordingly, the description of the information processing method according to the first example embodiment will be substituted by the following description of operations of the information processing apparatus 10.

As illustrated in FIG. 8, first, the exercise condition acquisition unit 11 acquires the execution duration of the exercise and the attack type specified by the participant as exercise conditions (step A1). The exercise condition acquisition unit 11 also inputs the acquired exercise conditions to the attack operation creation unit 12.

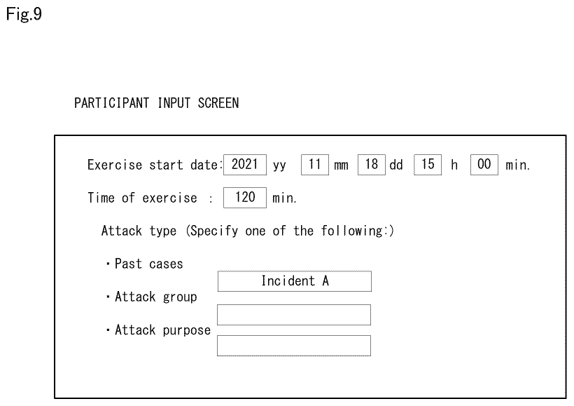

Specifically, as a premise, the participant specifies the start date and time of the exercise, the execution duration of the exercise, and the attack type at his/her own terminal device 30 as illustrated in FIG. 9. Accordingly, the terminal device 30 transmits information including the start date and time of the exercise, the execution duration of the exercise, and the attack type to the information processing apparatus 10. FIG. 9 is a diagram illustrating an example of an exercise condition specification screen.

Next, in the attack operation creation unit 12, the attack scenario creation unit 121 creates a scenario of attacks by a virtual attacker in accordance with the attack type specified by the participant (step A2).

Next, in the attack operation creation unit 12, the partial scenario extraction unit 122 extracts a part of the created attack scenario that falls within the execution duration of the exercise acquired as an exercise condition, as a partial scenario (step A3).

Then, the partial scenario extraction unit 122 determines whether each attack operation in the extracted partial scenario satisfies the extraction conditions included in the attack operation condition information 143 (step A4).

If it is determined in step A4 that each attack operation in the extracted partial scenario does not satisfy the extraction conditions included in the attack operation condition information 143 (step A4: No), the partial scenario extraction unit 122 causes the attack scenario creation unit 121 to execute step A2 again.

On the other hand, if it is determined in step A4 that each attack operation in the extracted partial scenario satisfies the extraction conditions included in the attack operation condition information 143 (step A4: Yes), the partial scenario verification unit 123 performs processing. The partial scenario verification unit 123 determines whether (step A5).

Specifically, the partial scenario verification unit 123 examines matching of the ID of the participant having specified the exercise conditions and the extracted partial scenario with the scenario information 144. The partial scenario verification unit 123 then compares the extracted part with the part extracted in the past for the identical participant, and determines whether the proportion of an overlap between the two is equal to or greater than a threshold. If it is determined that the proportion of an overlap between the two is equal to or greater than a threshold, the partial scenario verification unit 123 determines that the partial scenario is not appropriate. On the other hand, if the proportion of an overlap between the two is not equal to or greater than a threshold, the partial scenario verification unit 123 determines that the partial scenario is appropriate.

If it is determined in step A5 that the partial scenario extracted in step A3 is not appropriate (step A5: No), the partial scenario verification unit 123 causes the partial scenario extraction unit 122 to execute step A3 again and extract another partial scenario from the attack scenario.

If it is determined in step A5 that the partial scenario extracted in step A3 is appropriate (step A5: Yes), the execution sequence creation unit 124 uses the partial scenario to create a series of attack operations to be executed in the cybersecurity exercise (step A6).

The attack operation execution unit 13 then transmits the series of attack operations (execution sequence) created in step A6 to the computer system 40 for executing the cybersecurity exercise, and causes the computer system 40 to execute the series of attack operations (step A7).

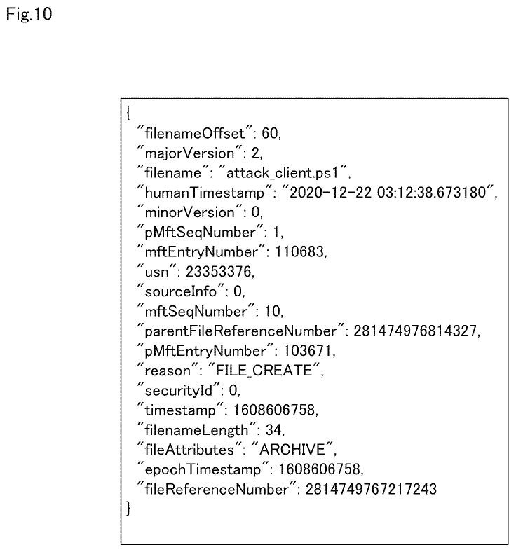

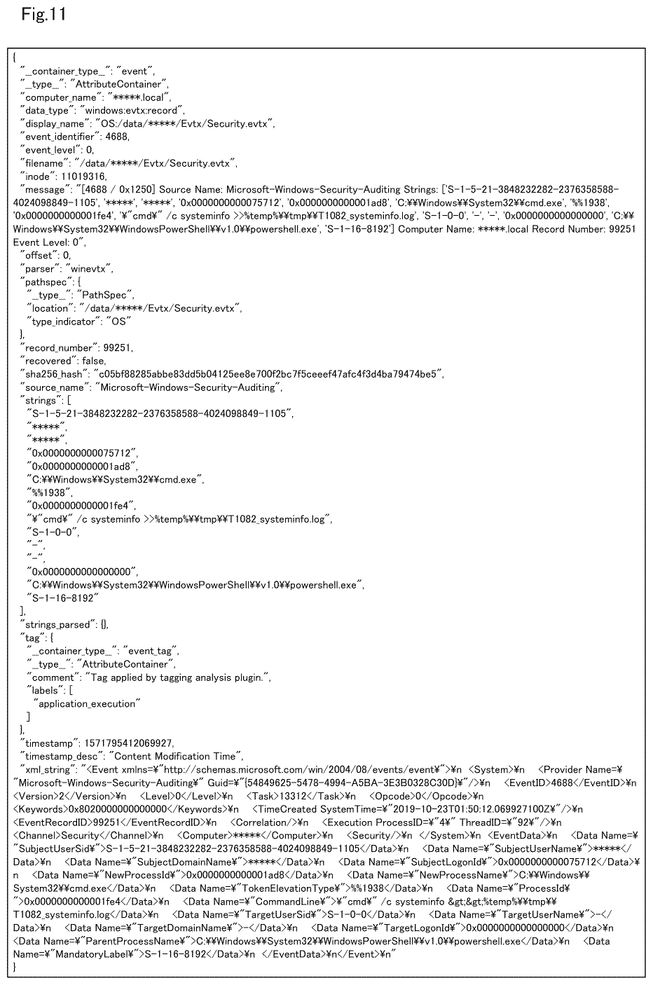

With execution of step A7, the processing performed by the information processing apparatus 10 is ended. After that, in the computer system 40, the commands are executed at the terminal device that is the attack destination. Then, the computer system 40 outputs logs that were collected during execution of the series of attack operations as illustrated in FIGS. 10 and 11. The output logs are used as training material in the participant's cybersecurity exercise.

FIG. 10 is a diagram illustrating an example of a log output by the computer system. The log illustrated in FIG. 10 is an event log that is acquired from the terminal device. FIG. 11 is a diagram illustrating another example of a log output by the computer system. The log illustrated in FIG. 11 is an update sequence number (USN) journal log that is acquired from the terminal device.

### Effects of First Example Embodiment

As above, in the example embodiment, the information processing apparatus 10 creates a series of attack operations to be executed in a cybersecurity exercise, in accordance with the start date and time of the exercise, the execution duration of the exercise, and the attack type that are specified by the participant of the cybersecurity exercise. Accordingly, the participant can conduct the cybersecurity exercise under the conditions specified by himself/herself. In addition, since the series of attack operations is different from that used in the past cybersecurity exercise conducted by the participant, the participant can efficiently improve his/her skills.

### [Program]

A program according to the first example embodiment is a program for causing a computer to execute steps A1 to A7 illustrated in FIG. 8. The information processing apparatus 10 and the information processing method according to the present example embodiment are realized by installing this program on the computer and executing the same. In this case, the processor in the computer functions as the exercise condition acquisition unit 11, the attack operation creation unit 12, and the attack operation execution unit 13 to perform processing. The computer may be a general-purpose PC, a smartphone, or a tablet-type terminal device.

In the example embodiment, the storage unit 14 may be realized by storing data files constituting the storage unit 14 in a storage device such as a hard disk included in the computer or may be realized by a storage device in another computer.

The program according to the first example embodiment may be executed by a computer system that is constructed of a plurality of computers. In this case, for example, each computer may function as one of the exercise condition acquisition unit 11, the attack operation creation unit 12, and the attack operation execution unit 13.

### Second Example Embodiment

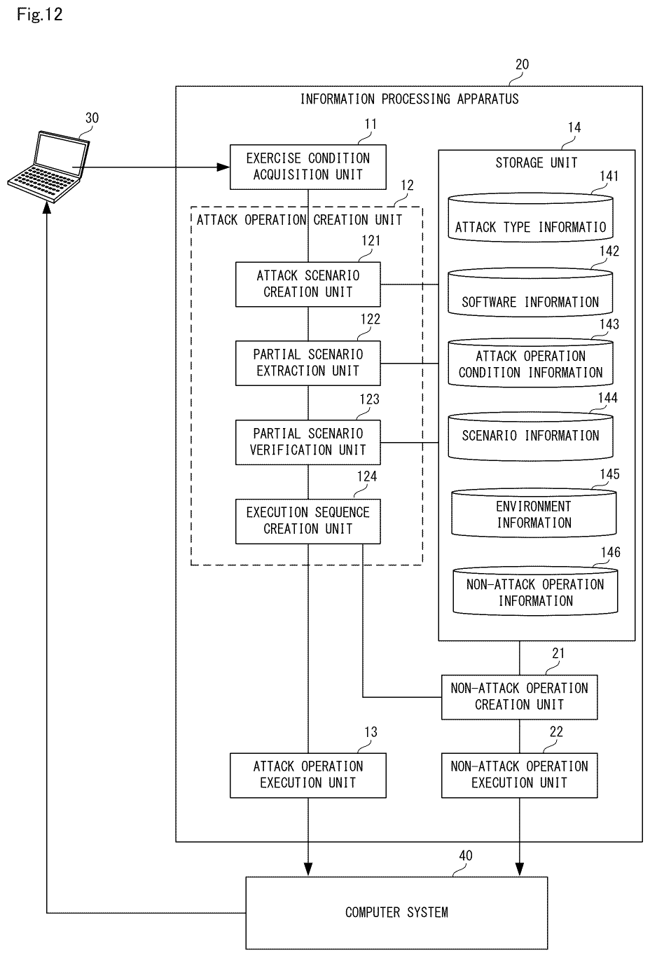

Next, an information processing apparatus, an information processing method, and a program according to a second example embodiment will be described with reference to FIGS. 12 to 14.

### [Apparatus Configuration]

First, a configuration of the information processing apparatus according to the second example embodiment will be described with reference to FIG. 12. FIG. 12 is a configuration diagram illustrating a configuration of the information processing apparatus according to the second example embodiment.

Like the information processing apparatus 10 according to the first example embodiment, an information processing apparatus 10 according to the second example embodiment illustrated in FIG. 12 is an apparatus for providing support to training for defense against cyberattacks, for example, providing a cybersecurity exercise.

As illustrated in FIG. 12, in the second example embodiment, the information processing apparatus 20 includes, in addition to an exercise condition acquisition unit 11, an attack operation creation unit 12, and an attack operation execution unit 13, a non-attack operation creation unit 21 and a non-attack operation execution unit 22, which is different from the information processing apparatus 10 according to the first example embodiment. A storage unit 14 stores, in addition to attack type information 141, software information 142, attack operation condition information 143, and scenario information 144, non-attack operation information 146. Hereinafter, differences from the first example embodiment will be mainly described.

The non-attack operation creation unit 21 creates non-attack operations that do not fall under the category of cyberattacks, using execution commands included in a series of attack operations created by the attack operation creation unit 12. In the second example embodiment, the non-attack operation creation unit 21 examines matching of the execution commands used in the series of attack operations (for example, OS standard commands, application programs, and the like) with the non-attack operation information 146, and selects non-attack operations including one or more operations using the same execution command.

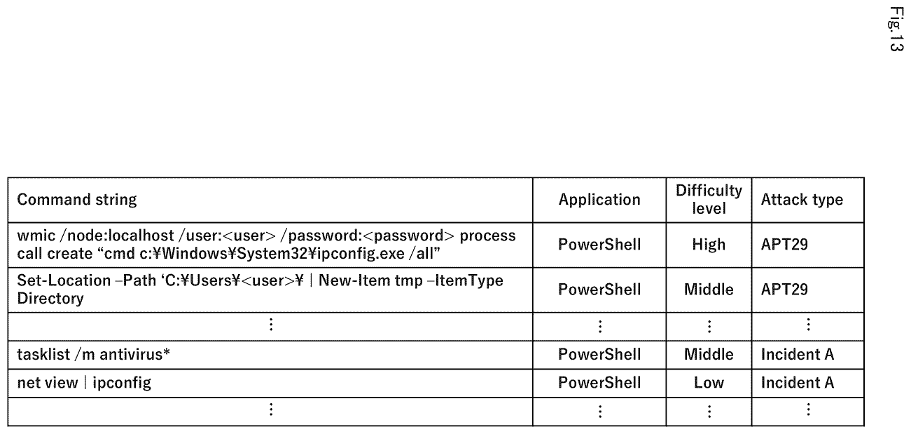

Operations of the non-attack operation creation unit 21 will be specifically described with reference to FIG. 13. FIG. 13 is a diagram illustrating an example of non-attack operation information used in the second example embodiment. As illustrated in FIG. 13, the non-attack operation information 146 is information for determining a command string using each application used in the attack type. The non-attack operation information 146 includes “Command string”, “Application”, “Difficulty level”, and “Attack type”. The difficulty level will be described later. Specifically, if the attack type specified by the participant is “APT29”, for example, the non-attack operation creation unit 21 selects a command string corresponding to “APT29” and sets the selected command string as non-attack operations. If the participant specifies the difficulty level in advance, the non-attack operation creation unit 21 may select a command string corresponding to the specified difficulty level.

The non-attack operation creation unit 21 may also create an operation log indicating user operations, using the techniques disclosed in Reference Documents 1 and 2 listed below, and set the same as non-attack operations.

### (Reference Document 1)

Yasuda et al., “Automatic Node Manipulation System for Active Monitoring Environment”, IEICE Technical Report 119 (140), 299-304, 2019 Jul. 23, [https://ci.nii.ac.jp/naid/40021970984] (Reference Document 2)
IEICE Technical Committee, “Automatic Node Manipulation System for Active Monitoring Environment”, [https: //www.ieice.org/publications/ken/summary.php?contribution_id=103289]

The non-attack operation execution unit 22 transmits the non-attack operations created by the non-attack operation creation unit 21 to a computer system 40, and causes the computer system 40 to execute the non-attack operations. Specifically, the non-attack operation execution unit 22 transmits the command string selected as the non-attack operations to the computer system 40. Accordingly, the computer system 40 causes a terminal device constituting the computer system 40 to execute the command string.

The computer system 40 can also select a command string to be executed at random from the transmitted command strings. The execution interval of the non-attack operations may be selected at random from predetermined values (for example, one minute, one minute and 300 seconds, two minutes, five minutes, ten minutes, and others) or may be an execution interval obtained by increasing or decreasing by several seconds a preset execution interval in order to enhance naturalness.

The computer system 40 can also create variations of a pseudo operation log from the existing user operation logs, using the technique disclosed in Reference Document 3 below.

### (Reference Document 3)

### [Apparatus Operations]

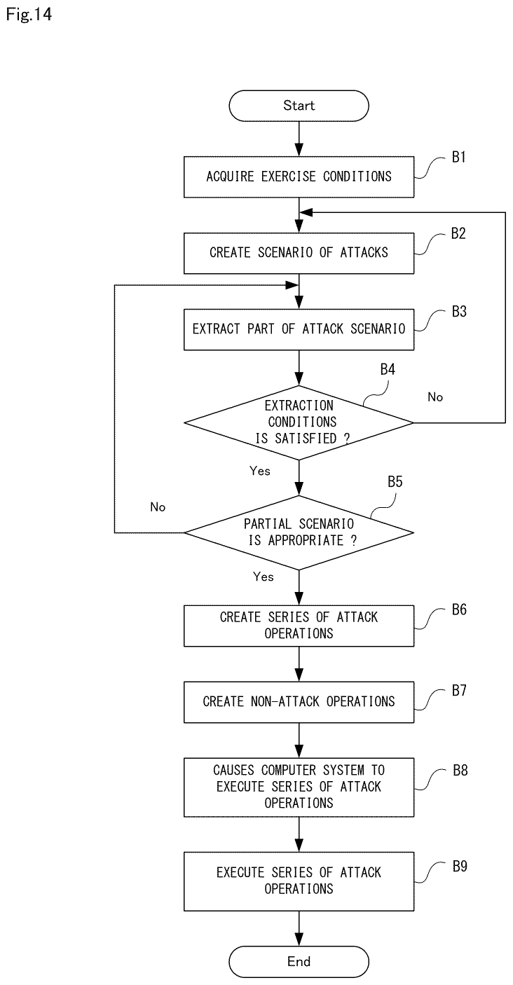

Next, operations of the information processing apparatus 10 according to the second example embodiment will be described with reference to FIG. 14. FIG. 14 is a flowchart of operations of the information processing apparatus according to the second example embodiment. In the following description, FIGS. 12 and 13 will also be referred to as appropriate. In the second example embodiment, an information processing method is implemented by operating the information processing apparatus 20. Accordingly, the description of the information processing method according to the second example embodiment will be substituted by the following description of operations of the information processing apparatus 20.

As illustrated in FIG. 14, first, the exercise condition acquisition unit 11 acquires the execution duration of the exercise and the attack type specified by the participant, as exercise conditions (step B1). Step B1 is similar to step A1 illustrated in FIG. 8.

Next, in the attack operation creation unit 12, an attack scenario creation unit 121 creates a scenario of attacks by a virtual attacker, in accordance with the attack type specified by the participant (step B2). Step B2 is similar to step A2 illustrated in FIG. 8.

Next, in the attack operation creation unit 12, a partial scenario extraction unit 122 extracts a part of the created attack scenario that falls within the execution duration of the exercise acquired as an exercise condition, as a partial scenario (step B3). Step B3 is similar to step A3 illustrated in FIG. 8.

The partial scenario extraction unit 122 determines whether each attack operation in the extracted partial scenario satisfies extraction conditions included in the attack operation condition information 143 (step B4). Step B4 is similar to step A4 illustrated in FIG. 8.

If it is determined in step B4 that each attack operation in the extracted partial scenario does not satisfy the extraction conditions included in the attack operation condition information 143 (step B4: No), the partial scenario extraction unit 122 causes the attack scenario creation unit 121 to execute step B2 again.

On the other hand, if it is determined in step B4 that each attack operation in the extracted partial scenario satisfies the extraction conditions included in the attack operation condition information 143 (step B4: Yes), the partial scenario verification unit 123 performs processing.

The partial scenario verification unit 123 determines whether the partial scenario extracted in step B3 is appropriate (step B5). Step B5 is similar to step A5 illustrated in FIG. 8.

If it is determined in step B5 that the partial scenario extracted in step A3 is not appropriate (step B5: No), the partial scenario verification unit 123 causes the partial scenario extraction unit 122 to execute step B3 again and extract another partial scenario from the attack scenario.

If it is determined in step B5 that the partial scenario extracted in step B3 is appropriate (step B5: Yes), the execution sequence creation unit 124 uses the partial scenario to create a series of attack operations to be executed in the cybersecurity exercise (step B6).

Next, the non-attack operation creation unit 21 creates non-attack operations that do not fall under the category of cyberattacks, using the execution commands included in the series of attack operations created in step B6 (step B7).

Next, the attack operation execution unit 13 transmits the series of attack operations (execution sequence) created in step B6 to the computer system 40 for executing the cybersecurity exercise, and causes the computer system 40 to execute the series of attack operations (step B8). Step B8 is similar to step A7 illustrated in FIG. 8.

Next, the non-attack operation execution unit 22 transmits the non-attack operations created in step B7 to the computer system 40, and causes the computer system 40 to also execute the non-attack operations (step B9). Step B9 may be executed at the same time as step B8.

With execution of step B9, the process performed by the information processing apparatus 10 is ended. After that, in the computer system 40, the commands are executed at the terminal device that is the attack target. Then, the computer system 40 outputs logs that were collected during execution of the series of attack operations and logs that were collected during execution of the non-attack operations. The output logs are used as training material in the participant's cybersecurity exercise.

### Effects of Second Example Embodiment

As above, also in the second example embodiment, the advantageous effects of the first example embodiment can be obtained. In addition, according to the second example embodiment, the computer system 40 outputs not only the logs that were collected during execution of the series of attack operations but also the logs during execution of the non-attack operations. Thus, the computer system 40 can add the logs obtained by execution of the non-attack operations to the logs obtained by execution of the series of attack operations. Therefore, according to the second example embodiment, it is possible to implement a cybersecurity exercise in which it is difficult to make a determination regarding discrimination between attacks or non-attacks.

### [Program]

A program according to the first example embodiment is a program for causing a computer to execute steps B1 to B9 illustrated in FIG. 14. The information processing apparatus 10 and the information processing method according to the present example embodiment are realized by installing this program on the computer and executing the same. In this case, the processor in the computer functions as the exercise condition acquisition unit 11, the attack operation creation unit 12, the attack operation execution unit 13, the non-attack operation creation unit 21 and the non-attack operation execution unit 22 to perform processing. The computer may be a general-purpose PC, a smartphone, or a tablet-type terminal device.

In the example embodiment, the storage unit 14 may be realized by storing data files constituting the storage unit 14 in a storage device such as a hard disk included in the computer or may be realized by a storage device in another computer.

The program according to the first example embodiment may be executed by a computer system that is constructed of a plurality of computers. In this case, for example, each computer may function as one of the exercise condition acquisition unit 11, the attack operation creation unit 12, the attack operation execution unit 13, the non-attack operation creation unit 21 and the non-attack operation execution unit 22.

### [Physical Configuration]

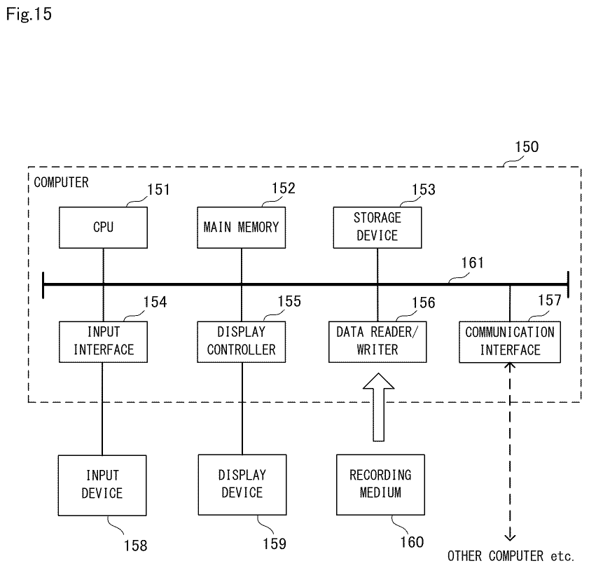

Using FIG. 15, the following describes a computer that realizes the information processing apparatus by executing the program according to the first and second example embodiment. FIG. 15 is a block diagram illustrating an example of a computer that realizes the information processing apparatus according to the first and second example embodiment.

As illustrated in FIG. 15, a computer 150 includes a CPU (Central Processing Unit) 151, a main memory 152, a storage device 153, an input interface 154, a display controller 155, a data reader/writer 156, and a communication interface 157. These components are connected in such a manner that they can perform data communication with one another via a bus 161.

The computer 150 may include a GPU (Graphics Processing Unit) or an FPGA (Field-Programmable Gate Array) in addition to the CPU 151, or in place of the CPU 151. In this case, the GPU or the FPGA can execute the program according to the example embodiment.

The CPU 151 deploys the program according to the example embodiment, which is composed of a code group stored in the storage device 153 to the main memory 152 and carries out various types of calculation by executing the codes in a predetermined order. The main memory 152 is typically a volatile storage device, such as a DRAM (dynamic random-access memory).

Also, the program according to the example embodiment is provided in a state where it is stored in a computer-readable recording medium 160. Note that the program according to the example embodiment may be distributed over the Internet connected via the communication interface 157.

Also, specific examples of the storage device 153 include a hard disk drive and a semiconductor storage device, such as a flash memory. The input interface 154 mediates data transmission between the CPU 151 and an input device 158, such as a keyboard and a mouse. The display controller 155 is connected to a display device 159, and controls display on the display device 159.

The data reader/writer 156 mediates data transmission between the CPU 151 and the recording medium 120, reads out the program from the recording medium 120, and writes the result of processing in the computer 150 to the recording medium 120. The communication interface 157 mediates data transmission between the CPU 151 and another computer.

Specific examples of the recording medium 160 include: a general-purpose semiconductor storage device, such as CF (CompactFlash®) and SD (Secure Digital); a magnetic recording medium, such as a flexible disk; and an optical recording medium, such as a CD-ROM (Compact Disk Read Only Memory).

Note that the information processing apparatus according to the first and second example embodiment can also be realized by using items of hardware that respectively correspond to the components rather than the computer in which the program is installed. Furthermore, a part of the information processing apparatus may be realized by the program, and the remaining part of the information processing apparatus may be realized by hardware.

A part or an entirety of the above-described example embodiment can be represented by (Supplementary Note 1) to (Supplementary Note 18) described below but is not limited to the description below.

### (Supplementary Note 1)

An information processing apparatus includes:
an exercise condition acquisition unit that acquires an execution duration of a cybersecurity exercise specified by a participant of the cybersecurity exercise, as an exercise condition; and
an attack operation creation unit that creates a series of attack operations to be executed in the cybersecurity exercise by creating a scenario of a cyberattack to be used in the cybersecurity exercise, and extracting a part of the created scenario that falls within the specified exercise duration.

### (Supplementary Note 2)

The information processing apparatus according to claim 1, wherein before extraction of the part, the attack operation creation unit determines whether the part satisfies an attack operation condition that defines whether or not the series of attack operations is to be executed, and if the attack operation condition is satisfied, the attack operation creation unit extracts the part.

### (Supplementary Note 3)

The information processing apparatus according to claim 1 or 2, wherein the attack operation creation unit further determines the participant who has specified the execution duration used in the extraction of the part, compares the extracted part with a part extracted in the past for the determined participant, and if a result of the comparison is that a proportion of an overlap between the two is equal to or greater than a threshold, the attack operation creation unit extracts again a part of the created scenario that falls within the execution duration and is different from the extracted part.

### (Supplementary Note 4)

The information processing apparatus according to any one of claims 1 to 3, wherein
the exercise condition acquisition unit acquires a type of a cyberattack specified by the participant as the exercise condition, and
the attack operation creation unit creates a scenario of the cyberattack in accordance with the type of the cyberattack specified by the participant.

### (Supplementary Note 5)

The information processing apparatus according to any one of claims 1 to 4, further includes an attack operation execution unit that causes a computer system for executing the cybersecurity exercise to execute the created series of attack operations.

### (Supplementary Note 6)

The information processing apparatus according to claim 5, further includes comprising:
a non-attack operation creation unit that creates a non-attack operation that does not fall under a category of the cyberattack, using an execution command included in the created series of attack operations; and
a non-attack operation execution unit that causes the computer system to execute the created non-attack operation.

### (Supplementary Note 7)

An information processing method includes:
an exercise condition acquisition step of acquiring an execution duration of a cybersecurity exercise specified by a participant of the cybersecurity exercise, as an exercise condition; and
an attack operation creation step of creating a series of attack operations to be executed in the cybersecurity exercise by creating a scenario of a cyberattack to be used in the cybersecurity exercise, and extracting a part of the created scenario that falls within the specified

### (Supplementary Note 8)

The information processing method according to claim 7, wherein in the attack operation creation step, before extraction of the part, determining whether the part satisfies an attack operation condition that defines whether or not the series of attack operations is to be executed, and if the attack operation condition is satisfied, extracting the part.

### (Supplementary Note 9)

The information processing method according to claim 7 or 8, wherein in the attack operation creation step, determining the participant who has specified the execution duration used in the extraction of the part, comparing the created series of attack operations with a series of attack operations created in the past for the determined participant, and if a result of the comparison is that a proportion of an overlap between the two is equal to or greater than a threshold, extracting again a part of the created scenario that falls within the execution duration and is different from the extracted part.

### (Supplementary Note 10)

The information processing method according to any one of claims 7 to 9, wherein
in the exercise condition acquisition step, acquiring a type of a cyberattack specified by the participant as the exercise condition, and
in the attack operation creation step, creating a scenario of the cyberattack in accordance with the type of the cyberattack specified by the participant.

### (Supplementary Note 11)

The information processing method according to any one of claims 7 to 10, further includes an attack operation execution step of causing a computer system for executing the cybersecurity exercise to execute the created series of attack operations.

### (Supplementary Note 12)

The information processing method according to claim 11, further includes comprising:
a non-attack operation creation step of creating a non-attack operation that does not fall under a category of the cyberattack, using an execution command included in the created series of attack operations; and
a non-attack operation execution step of causing the computer system to execute the created non-attack operation.

### (Supplementary Note 13)

A computer readable recording medium that includes a program recorded thereon, the program including instructions that causes a computer to carry out:
an exercise condition acquisition step of acquiring an execution duration of a cybersecurity exercise specified by a participant of the cybersecurity exercise, as an exercise condition; and
an attack operation creation step of creating a series of attack operations to be executed in the cybersecurity exercise by creating a scenario of a cyberattack to be used in the cybersecurity exercise, and extracting a part of the created scenario that falls within the specified exercise duration.

### (Supplementary Note 14)

The computer readable recording medium according to claim 13, wherein in the attack operation creation step, before extraction of the part, determining whether the part satisfies an attack operation condition that defines whether or not the series of attack operations is to be executed, and if the attack operation condition is satisfied, extracting the part.

### (Supplementary Note 15)

The computer readable recording medium according to claim 13 or 14, wherein in the attack operation creation step, determining the participant who has specified the execution duration used in the extraction of the part, comparing the created series of attack operations with a series of attack operations created in the past for the determined participant, and if a result of the comparison is that a proportion of an overlap between the two is equal to or greater than a threshold, extracting again a part of the created scenario that falls within the execution duration and is different from the extracted part.

### (Supplementary Note 16)

The computer readable recording medium according to any one of claims 13 to 15, wherein
in the exercise condition acquisition step, acquiring a type of a cyberattack specified by the participant as the exercise condition, and
in the attack operation creation step, creating a scenario of the cyberattack in accordance with the type of the cyberattack specified by the participant.

### (Supplementary Note 17)

The computer readable recording medium according to any one of claims 13 to 16, wherein the program further including instructions that causes the computer to carry out an attack operation execution step of causing a computer system for executing the cybersecurity exercise to execute the created series of attack operations.

### (Supplementary Note 18)

The computer readable recording medium according to claim 17, wherein the program further including instructions that causes the computer to carry out:
a non-attack operation creation step of creating a non-attack operation that does not fall under a category of the cyberattack, using an execution command included in the created series of attack operations; and
a non-attack operation execution step of causing the computer system to execute the created non-attack operation.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

According to the present discloser, it is possible to provide a cybersecurity exercise that is suited to each individual participant's wish. The present disclosure is useful in fields where training against cyberattacks is required.

### REFERENCE SIGNS LIST

10 Information processing apparatus (first example embodiment)
11 Exercise condition acquisition unit
12 Attack operation creation unit
13 Attack operation execution unit
20 Information processing apparatus (second example embodiment)
21 Non-attack operation creation unit
22 Non-attack operation execution unit
30 Terminal device
40 Computer system
121 Attack scenario creation unit
122 Partial scenario extraction unit
123 Partial scenario verification unit
124 Execution sequence creation unit
141 Attack type information
142 Software information
143 Attack operation condition information
144 Scenario information
145 Environment information
146 Non-attack operation information
150 Computer
151 CPU
152 Main memory
153 Storage device
154 Input interface
155 Display controller
156 Data reader/writer
157 Communication interface
158 Input device
159 Display device
160 Recording medium
161 Bus

What is claimed is:

1. An information processing apparatus comprising:
at least one memory storing instructions; and
at least one processor configured to execute the instructions to:
acquire an execution duration of a cybersecurity exercise specified by a participant of the cybersecurity exercise, as an exercise condition; and
create a series of attack operations to be executed in the cybersecurity exercise by creating a scenario of a cyberattack to be used in the cybersecurity exercise, and extracting a part of the created scenario that falls within the specified exercise duration.

2. The information processing apparatus according to claim 1,
wherein the processor further:
before extraction of the part, determines whether the part satisfies an attack operation condition that defines whether or not the series of attack operations is to be executed, and if the attack operation condition is satisfied, the attack operation creation means extracts the part.

3. The information processing apparatus according to claim 1,
wherein the processor further:
determines the participant who has specified the execution duration used in the extraction of the part, compares the extracted part with a part extracted in the past for the determined participant, and if a result of the comparison is that a proportion of an overlap between the two is equal to or greater than a threshold, the attack operation creation means extracts again a part of the created scenario that falls within the execution duration and is different from the extracted part.

4. The information processing apparatus according to claim 1,
wherein the processor further:
acquires a type of a cyberattack specified by the participant as the exercise condition, and
creates a scenario of the cyberattack in accordance with the type of the cyberattack specified by the participant.

5. The information processing apparatus according to claim 1,
wherein the processor further:
causes a computer system for executing the cybersecurity exercise to execute the created series of attack operations.

6. The information processing apparatus according to claim 5,
wherein the processor further:
creates a non-attack operation that does not fall under a category of the cyberattack, using an execution command included in the created series of attack operations; and
causes the computer system to execute the created non-attack operation.

7. An information processing method comprising:
acquiring an execution duration of a cybersecurity exercise specified by a participant of the cybersecurity exercise, as an exercise condition; and
creating a series of attack operations to be executed in the cybersecurity exercise by creating a scenario of a cyberattack to be used in the cybersecurity exercise, and extracting a part of the created scenario that falls within the specified exercise duration.

8. The information processing method according to claim 7, wherein the creating the attack operations includes, before extraction of the part, determining whether the part satisfies an attack operation condition that defines whether or not the series of attack operations is to be executed, and if the attack operation condition is satisfied, extracting the part.

9. The information processing method according to claim 7, wherein the creating the attack operations further includes determining the participant who has specified the execution duration used in the extraction of the part, comparing the created series of attack operations with a series of attack operations created in the past for the determined participant, and if a result of the comparison is that a proportion of an overlap between the two is equal to or greater than a threshold, extracting again a part of the created scenario that falls within the execution duration and is different from the extracted part.

10. The information processing method according to claim 7, wherein
the acquiring the exercise condition includes acquiring a type of a cyberattack specified by the participant as the exercise condition, and
the creating the attack operations includes creating a scenario of the cyberattack in accordance with the type of the cyberattack specified by the participant.

11. The information processing method according to claim 7, further comprising causing a computer system for executing the cybersecurity exercise to execute the created series of attack operations.

12. The information processing method according to claim 11, further comprising:
creating a non-attack operation that does not fall under a category of the cyberattack, using an execution command included in the created series of attack operations; and
causing the computer system to execute the created non-attack operation.

13. A non-transitory computer readable recording medium that includes a program recorded thereon, the program including instructions that causes a computer to carry out:
acquiring an execution duration of a cybersecurity exercise specified by a participant of the cybersecurity exercise, as an exercise condition; and
creating a series of attack operations to be executed in the cybersecurity exercise by creating a scenario of a cyberattack to be used in the cybersecurity exercise, and extracting a part of the created scenario that falls within the specified exercise duration.

14. The non-transitory computer readable recording medium according to claim 13, wherein the creating the attack operations includes, before extraction of the part, determining whether the part satisfies an attack operation condition that defines whether or not the series of attack operations is to be executed, and if the attack operation condition is satisfied, extracting the part.

15. The non-transitory computer readable recording medium according to claim 13, wherein the creating the attack operations further includes determining the participant who has specified the execution duration used in the extraction of the part, comparing the created series of attack operations with a series of attack operations created in the past for the determined participant, and if a result of the comparison is that a proportion of an overlap between the two is equal to or greater than a threshold, extracting again a part of the created scenario that falls within the execution duration and is different from the extracted part.

16. The non-transitory computer readable recording medium according to claim 13, wherein
the acquiring the exercise condition includes acquiring a type of a cyberattack specified by the participant as the exercise condition, and
the creating the attack operations includes creating a scenario of the cyberattack in accordance with the type of the cyberattack specified by the participant.

17. The non-transitory computer readable recording medium according to claim 13, wherein the program further including instructions that causes the computer to carry out causing a computer system for executing the cybersecurity exercise to execute the created series of attack operations.

18. The non-transitory computer readable recording medium according to claim 17, wherein the program further including instructions that causes the computer to carry out:
creating a non-attack operation that does not fall under a category of the cyberattack, using an execution command included in the created series of attack operations; and
causing the computer system to execute the created non-attack operation.
